(19) United States
(12) Patent Application Publication
(10) Pub. No.: US 2001/0044324 A1
(43) Pub. Date: Nov. 22, 2001

(54) Cellular telephone

(76) Inventors: Peter Carayiannis, Mississauga (CA); T. Andrew Currier, Toronto (CA)

Correspondence Address: Andrew Currier, 160 Baldwin Street, Suite 405, Toronto, ON, M5T 3K7, CA

(21) Appl. No.: 09/732,305

(22) Filed: Dec. 8, 2000

Related U.S. Application Data
(60) Provisional application No. 60/170,525, filed on Dec. 13, 1999.

(51) Int. Cl. H04M 1/00

(52) U.S. Cl. 455/564; 455/550; 455/566

(57) ABSTRACT

A business card and an associated intelligent device are provided. In one embodiment, the business card is a conventional business card bearing information about the owner of the card and further included a machine readable indicia, such as a barcode. The indicia is encoded to represent the information born on the card. The intelligent device, which is typically a cellular telephone, includes a reader that is operable to receive the indicia, and a processor that is operable to decode the indicia into an electronic data representative of the information. Typically, the electronic data is divided into a plurality of fields, and is stored in a telephone or address directory within the device. The cell phone or other intelligent device is operable to dial a telephone number contained in the indicia.

### FIELD OF THE INVENTION

The present invention relates generally to office automation and more particularly relates to a machine readable business card and an associated cellular telephone.

### BACKGROUND OF THE INVENTION

Business cards are well known and are the primary means used by individuals to quickly convey relevant information about the individual. It is thus customary for professionals to exchange business cards during an initial meeting to efficiently exchange this information prior to business discussions. The modem business card can trace its roots back to a whole range of paper-based office stationary products. In paper-based office systems, an individual would generally keep a complex Rolodex or other type of filing system for business cards. In order to consolidate business cards, the individual might transcribe the information from a business card into a paper-based planner or address book.

The advent of computers has drastically changed office automation. Paper-based planners Rolodexes and address books are rapidly being replaced by computer-based electronic planners and databases that efficiently store contact information found on business cards. Personal digital assistants and mobile phones (also referred to as cell phones) are now a common way to store such information, and provide a convenient, portable means for individuals to store and carry contact information.

Despite the move towards paperless offices, it is still common for individuals to carry business cards. Unfortunately, a receiver of the card who relies on a personal digital assistant to carry this information must generally manually enter the data contained on the business card into the personal digital assistant.

Optical scanners, and specialized business card scanners, are known which can capture an image of the business card and convert the information thereon into electronic data. Optical character recognition programs can then be used to attempt to automatically decipher this electronic data and carve up the information into the associated fields of the electronic address-book resident on the personal digital assistant. However, as is known to those of skill in the art, such optical character recognition programs are expensive, and not entirely accurate.

One solution to the foregoing problems is taught in U.S. Pat. No. 5,483,052 to Smith. Smith teaches, amongst other things, a business card with a bar-code. The bar-code contains a machine-readable representation of the contents of the card, which is encapsulated into a variety of fields. Smith also teaches the use of a system comprising bar code reader, connected to a personal computer or personal organizer, such as a Sharp Wizard. The system is operable to read the bar-code and transfer the data contained in the bar-code directly into the memory of the computer or organizer.

Mobile telephones are also now increasingly commonplace, and are capable of storing several names and telephone numbers. Unfortunately, current mobile phones generally require the subscriber to manually enter each of the names and numbers frequently dialed by the subscriber. Thus, while systems are known to readily transfer information from business cards to computers and personal organizers, it is still difficult for subscribers to fill the entries of their mobile telephones.

### SUMMARY OF THE INVENTION

It is therefore an object of the invention to provide a novel business card and mobile telephone that obviates or mitigates at least one of the disadvantages of the prior art.

In accordance with an embodiment of the invention, there is provided a business card comprising an encoded indicia having information representative of an owner of the business card such that a reader complementary to a format of the indicia can read the indicia and present the information as an electronic record.

In accordance with another embodiment of the invention, there is provided a cellular telephone comprising: a housing; a reader within the housing, the reader being operable to receive an encoded indicia on a business card, the encoded indicia being representative of information about a respective owner of the business card; a processor within the housing and connected to receive the indicia from the reader, the processor being operable to actuate the reader and decode at least a portion of the indicia received from the reader; and, an output device connected to the processing unit for presenting at least a portion of the decoded information. The cellular telephone can be further operable to automatically dial a telephone number embedded in the decoded information.

In accordance with another embodiment of the invention, there is provided computer-based method of reading a business card having a machine-readable indicia, the indicia being representative of information about an owner of the business card, the method comprising the steps of: reading the machine-readable indicia on the business card; decoding the indicia into an electronic record; and presenting the record to a user.

### BRIEF DESCRIPTION OF THE DRAWING

The present invention will now be explained, by way of example only, with reference to certain embodiments and the accompanying Figures in which:

FIG. 1 is the front side of a business card in accordance with an embodiment of the invention;

FIG. 2 is the back side of the business card of FIG. 1;

FIG. 3 is a front view of a cell phone in accordance with another embodiment of the invention;

FIG. 4 is an end view of the device of FIG. 3;

FIG. 5 is a block-diagram of components resident within the device of FIG. 3; and,

FIG. 6 is a front view of the device of FIG. 3 being used to scan the business card of FIG. 2;

### DETAILED DESCRIPTION OF THE INVENTION

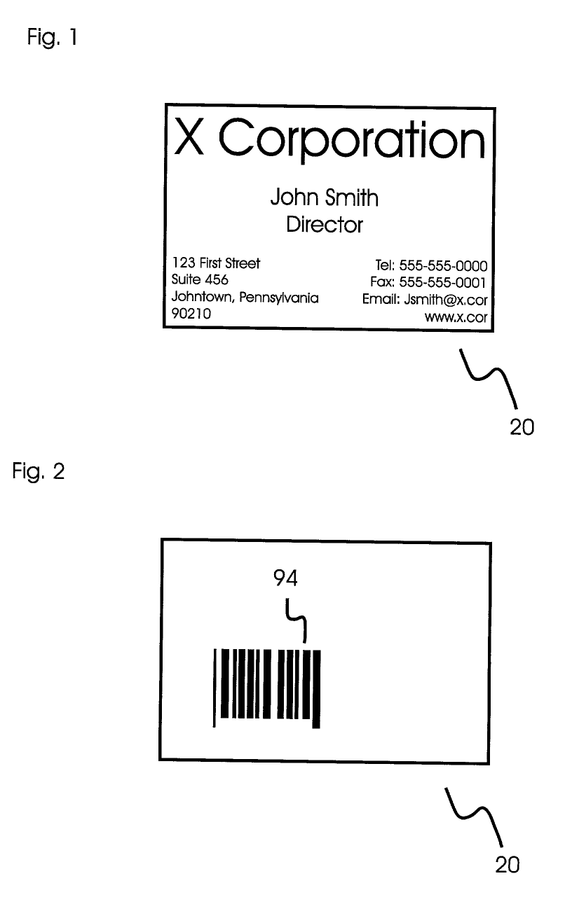

Referring now to FIGS. 1 and 2, a business card in accordance with an embodiment of the invention is indicated generally at 20. As best seen in FIG. 1, the front of card 20 has a variety of information contained in a plurality of fields, including a company, a last name, a first name, a title, an address, a city, a state, a zip code, a country, a telephone number, a fax number, an email address and a website address. While not included in the present embodiment, it will be understood that card 20 can bear less or more information and/or can include graphics, trade-marks or logos, as desired.

As best seen in FIG. 2, the back of card 20 includes a machine-readable indicia, which in the present embodiment is a barcode 94 readable by a barcode scanner. Barcode 94 is patterned so as to include, in a machine-readable format, all of the information shown on the front of card 20. Any means of encoding barcode 94 can be used, as will occur to those of skill in the art. Compression algorithms can also be used to reduce the length of barcode 94. It is presently preferred that the information on barcode 94 is encoded according to a predetermined format, so that each field is stored within a predetermined zone on barcode 94. Any format can be used, as will occur to those of skill in the art.

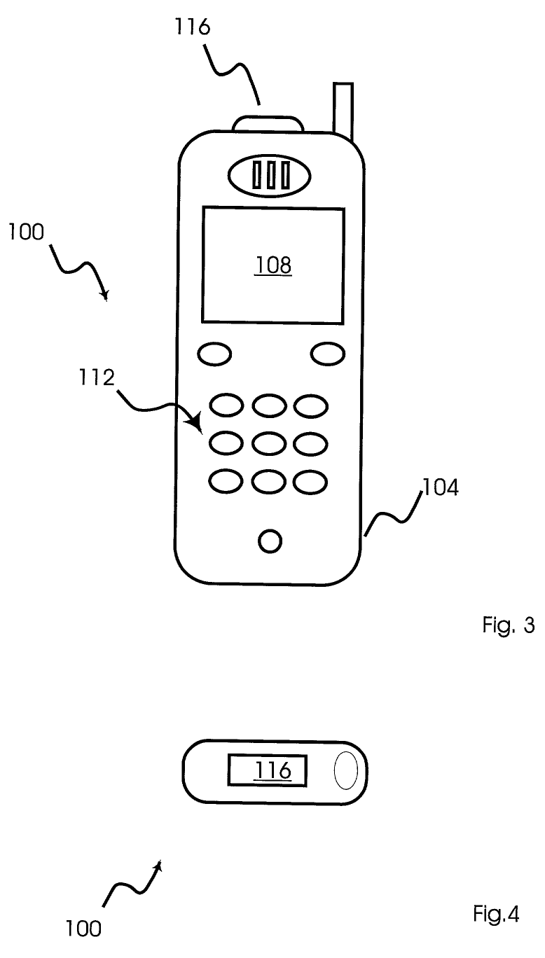

Referring now to FIGS. 3-4, a cellular telephone in accordance with another embodiment of the invention is indicated generally at 100. Cellular telephone 100 can include the construction and any of the functionality of cellular telephone known in the art, such as the 6100™ series models by Nokia™. Such telephones 100 can be based on any known wireless multiple access protocol, such as GSM, TDMA, CDMA, FDMA or the like. In a present embodiment, cellular telephone 100 includes a housing 104, which frames a display 108, a keypad 112 and a scanning window 116. It will be understood that display 108 can be based on any display technology known in the art, such as a liquid crystal display or an electroluminescent display. Housing 104 can be made from any suitable material, preferably a durable, lightweight plastic or metal, as will occur to those of skill in the art.

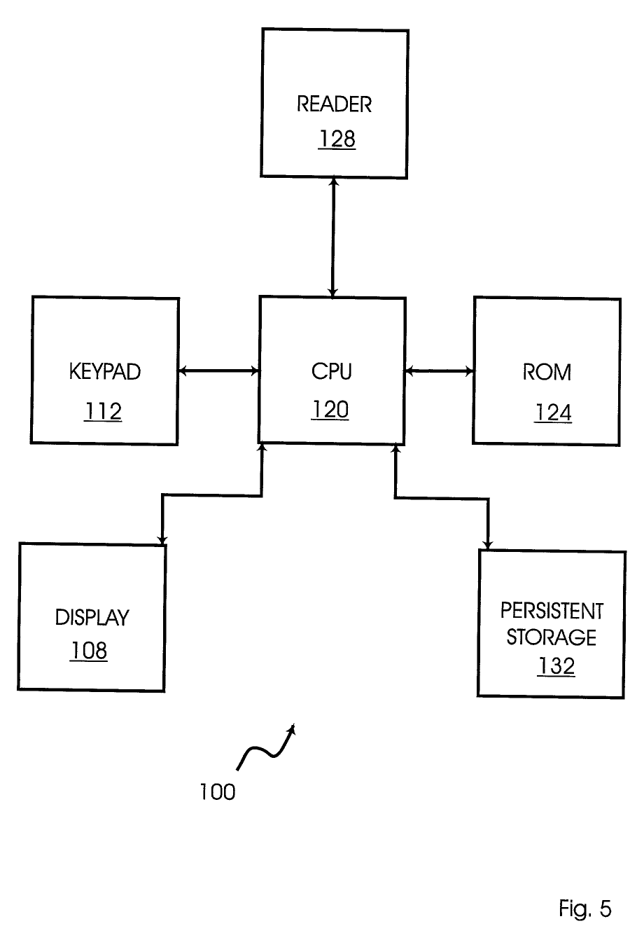

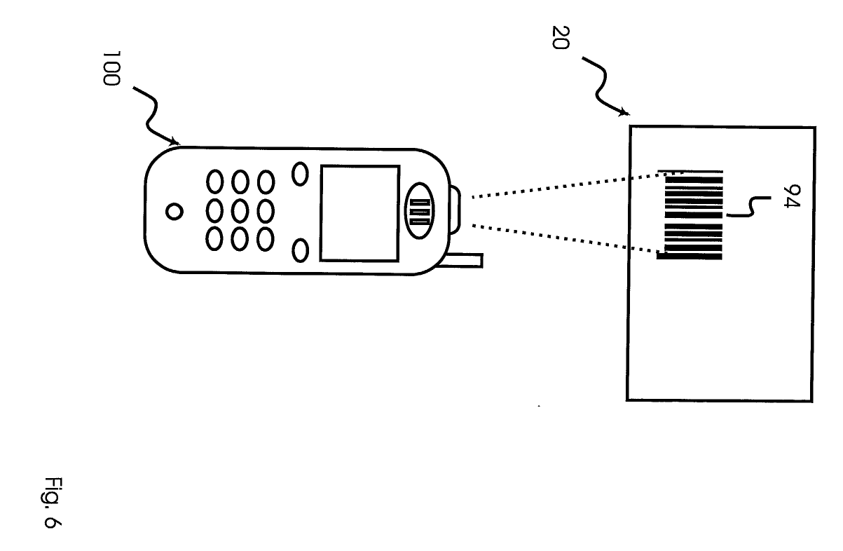

Referring now to FIG. 5, a block diagram of certain internal components within cellular telephone 100 are shown. Cellular telephone 100 includes a processor 120 that is connected to a read-only-memory (“ROM”) 124, which contains a program executable by processor 120 that enables processor 120 to perform certain functions over cellular telephone 100. Processor 120 is also connected to a reader or bar-code scanner 128 that is mounted proximal scanning window 116 so as to be able to project a scanning laser therethrough. Suitable compact models of bar-code scanner 120 are available from Symbol Technologies, Inc. 709 West Algonquin Road, Arlington Heights, Ill. 60005, USA. Such a scanner is found in Product PPT2700 Series Palm-size PC's, also available from Symbol Technologies.

Processor 120 is further operable to actuate scanner 120 based on a predetermined event, such as an input received from a key on keypad 112. When actuated, scanner 120 is operable to read barcode 94 and transmit electronic data representative of barcode 94 to processor 120. Processor 120 is further operable to decode the electronic data representing barcode 94 and perform an operation that determines the information about the owner of card 20. Preferably, the data is decoded into predetermined fields corresponding to a telephone directory program incorporated into cellular telephone 100, the fields being shown in the following table:

TABLE I

Company
Last Name
First Name
Title
Address
City
State
Zip Code
Country
Telephone Number
Fax Number
Email Address
Website Address

Processor 120 is further operable to present the decoded information on display 108, and/or store the data in a persistent storage device 132, such as an EEPROM or smart-card, mounted within housing 104.

Processor 120 is further operable to automatically dial the telephone number retrieved from the decoded information based on a predetermined event, such as an input received from a key on keypad 112.

A method of electronically reading a business card, in accordance with another embodiment of the invention, will now be described with reference to business card 20 and cellular telephone 100. First, cellular telephone is turned on, and oriented so that scanning window 116 is proximal to barcode 94. Next, scanner 120 is actuated. Scanner 120 can be actuated based on any predetermined condition, such as the depression of a key on keypad 112. Upon actuation of scanner 120, the laser emitted therefrom sweeps barcode 94, reading the encoded lines therein. The electronic data representing barcode 94 is then transmitted to processor 120, which decodes the electronic data into fields and a data format the corresponds with the telephone directory program. The decoded data is shown in the following table:

TABLE II

| | |
|---|---|
| Company | X Corporation |
| Last Name | Smith |
| First Name | John |
| Title | Director |
| Address | 123 First Street, Suite 456 |
| City | Johntown |
| State | Pennsylvania |
| Zip Code | 90210 |
| Country | USA |
| Telephone Number | 555-555-0000 |
| Fax Number | 555-555-0001 |
| Email Address | jsmith@x.cor |
| Website Address | www.x.cor |

The information of Table II is now stored as a record within the telephone directory program of cellular telephone 100, and can thus be displayed on display 108 in the usual fashion. In addition, as the information of Table II is now in the form of an electronic record, the record can be processed in any number of known ways, such as searching, sorting, or transferral to another computer that is connectable to cellular telephone 100. It is also contemplated that the processing can include automatically dialing the telephone number decoded from card 20, either directly when card 20 is decoded or by retrieving the number for memory. Other ways of processing the record will occur to those of skill in the art.

While the embodiments discussed herein are directed to particular implementations of the present invention, it will be apparent that the sub-sets and variations to these embodiments are within the scope of the invention. For example, other types of intelligent devices, other than mobile phones are within the scope of the invention. For example, point-of-purchase machines, desk-top computers, automated teller machines and any other type of intelligent device incorporating the minimum necessary components to read and decode a business card bearing complementary machine readable indicia are within the scope of the invention.

Other types of output devices, in addition to, or in lieu of display 108 can be used. For example, where the present invention is incorporated into a personal digital assistant instead of a cellular telephone, then a speaker and a sound generation chip can be used to produce output. Outputted sound can be in the form of speech that reads the contents of the information, or generate DTMF tones to automatically dial a touch-tone™ telephone by placing the speaker of the device 108 next to the mouth-piece of the telephone. A USB port, infrared port, serial port, wireless link or other type of network interface can also be incorporated as an output device, allowing decoded information from the business card to be transmitted to another intelligent device or computer.

It is also contemplated that, where the cell phone or other intelligent device is operable send emails, then an email address retrieved from the business card can be used to automatically create a recipient list in an email.

Other types of input devices, in addition to, or in lieu of keypad 112 can be used. For example, a touch screen or mouse can be used.

Other machine readable indicia can be used. For example, the business card can contain a smart-card that has personal data about the owner of the card stored thereon. Alternatively, the business card can have indicia in the form of a magnetic strip. Other machine readable indicia will occur to those of skill in the art.

It will be understood that the business card need not include any markings that are recognizable to a person, but simply includes the machine-readable indicia such a barcode.

The machine-readable indicia can be an encoded hash of the business card.

The machine-readable indicia can include security features, that specifically identify the owner of the business card, including a photograph or representation of the owner's written signature.

The machine-readable indicia can include a public encryption key that is proprietary to the owner of the business card, allowing the owner of the business card to readily send encrypted electronic messages to the recipient of the business card.

The present invention provides a novel business card and an associated cell phone. The business card includes a machine readable indicia, such as a barcode, that contains information about the owner of the business card. The business card typically includes traditional human-readable visual information, so that a recipient of the card can study the human-readable visual information and learn about the owner of the card, but can then later transfer the human-readable visual information to an intelligent device including a reader or scanner so that the device is operable to read the indicia and convert indicia into an electronic record representative of the human-readable visual information about the owner of the card. The cell phone is then operable to automatically dial a telephone number contained within the indicia, thereby saving the tediousness and potential errors of manually entering the information from the business card into the cell phone.

We claim:

1. A mobile telephone comprising:
a housing;
a reader within said housing, said reader being operable to receive an encoded indicia on a business card, said encoded indicia being representative of information about a respective owner of said business card;
a processor within said housing and connected to receive said indicia from said reader, said processor being operable to actuate said reader and decode at least a portion of said indicia received from said reader; and,
an output device connected to said processing unit for presenting at least a portion of said decoded information.

2. The mobile telephone according to claim 1 further comprising a dialer operable to dial a telephone number encoded within said indicia.

3. The mobile telephone according to claim 1 wherein said indicia is a barcode and said reader is a barcode reader.

4. The mobile telephone according to claim 1 wherein said output device is a speaker.

5. The mobile telephone according to claim 1 wherein said output device is a display screen.

6. A computer-based method of reading a business card having a machine-readable indicia, said indicia being representative of information about an owner of said business card, said method comprising the steps of:
reading said machine-readable indicia on said business card;
decoding said indicia into an electronic record; and
storing said decoded indicia in a memory device of a mobile telephone.

7. The method according to claim 6 wherein said indicia is a bar code.

8. The method according to claim 6 further comprising the steps of:
retrieving a telephone number incorporated into said decoded indicia from said memory device;
activating a dialer device within said telephone and dialing said retrieved telephone number.

9. A computer based method of dialing a telephone number comprising the steps of:
reading a machine-readable indicia from a business card, said indicia including a telephone number;
decoding said indicia into an electronic record; and
activating a telephone dialer using said telephone number decoded from said indicia.

10. The method according to claim 9 wherein said indicia is a bar code.
